(19) United States
(12) Patent Application Publication
(10) Pub. No.: US 2021/0370954 A1
(43) Pub. Date: Dec. 2, 2021

(54) MONITORING AND SCORING PASSENGER ATTENTION

(71) Applicant: Intel Corporation, Santa Clara, CA (US)

(72) Inventors: Ignacio J. ALVAREZ, Portland, OR (US); Cornelius BUERKLE, Karlsruhe (DE); Florian GEISSLER, Munich (DE); Marcio JULIATO, Portland, OR (US); Fabian OBORIL, Karslruhe (DE); Frederik PASCH, Karslruhe (DE); Ivan SIMOES GASPAR, West Linn, OR (US)

(21) Appl. No.: 17/401,341

(22) Filed: Aug. 13, 2021

(51) Int. Cl. B60W 40/08; G06K 9/00; G08G 1/01

(52) U.S. Cl. CPC B60W 40/08; G06K 9/00832; G08G 1/0133; B60W 2540/221; B60W 2554/4048; B60W 2554/4049; B60W 2540/225; G08G 1/0145

(57) ABSTRACT

Disclosed herein is a passenger monitoring system for monitoring an observed attribute of a passenger in a vehicle. The observed attribute may include a gaze of the passenger, a head track of the passenger, and other observations about the passenger in the vehicle. Based on the observed attribute(s), a field of view of the passenger may be determined. Based on the field of view, a focus point of the passenger may be determined, where the focus point is estimated to be within the field of view. If a sign (e.g., a road sign, a billboard, etc.) is within the field of view of the passenger, record an attention score for the sign based on a duration of time during which the sign is within the field of view and estimated to be the focus point of the passenger.

### TECHNICAL FIELD

The disclosure relates generally to vehicle monitoring systems, and in particular, to vehicle monitoring systems that observe passengers inside the vehicle and their reaction to an external stimulus.

### BACKGROUND

Today's vehicles, and in particular, autonomous or partially autonomous vehicles, include a variety of monitoring systems, usually equipped with a variety of cameras and other sensors, to observe information about the interior of the vehicle, the motion of the vehicle, and objects outside the vehicle.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 illustrates an example of how passenger(s) in vehicle(s) may pay attention to various objects outside the vehicle;

FIG. 2 shows a schematic drawing illustrating an exemplary passenger monitoring system for monitoring the attention of a passenger to an external stimulus;

FIG. 3 depicts an exemplary grid that shows aggregated attention impact information associated with map data, including cell attention scores for the objects/signs at a given geographic location;

FIG. 4 shows an exemplary feature analyzer that may identify which observed attributes of a passenger might be worth storing with an associated relevance score;

FIG. 5 shows an exemplary schematic drawing illustrating a device for monitoring passengers in a vehicle;

FIG. 6 depicts a schematic flow diagram of a method for monitoring a passenger in a vehicle.

### DESCRIPTION

The following detailed description refers to the accompanying drawings that show, by way of illustration, exemplary details and features.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

A “vehicle” may be understood to include any type of driven object. By way of example, a vehicle may be a driven object with a combustion engine, a reaction engine, an electrically driven object, a hybrid driven object, or a combination thereof. A vehicle may be or may include an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, or a rocket, among others.

A “passenger” may be understood to include any person within a vehicle. By way of example, a passenger may be seated in what may be understood as the driver's seat (e.g., behind a steering wheel) or the passenger's seat (e.g., not behind the steering wheel). A passenger may be understood to be the “driver” of the vehicle, regardless as to whether the driver is actively controlling the vehicle (e.g., the vehicle may be controlled by an autonomous driving mode or a partially autonomous driving mode) or simply allowing the autonomous mode to control the vehicle.

The apparatuses and methods described herein may be implemented using a hierarchical architecture, e.g., by introducing a hierarchical prioritization of usage for different types of users (e.g., low/medium/high priority, etc.), based on a prioritized access to the spectrum (e.g., with highest priority given to tier-1 users, followed by tier-2, then tier-3, etc.).

Today's vehicles, and in particular autonomous or partially autonomous vehicles, are equipped with monitoring systems that are typically related to safety systems for warning a driver or assisting a driver in reacting to objects that may appear in the vehicle's vicinity. The monitoring systems typically include a variety of inputs, sensors, cameras, and other information-gathering devices to assist the driver and/or the vehicle in making decisions based on those inputs for safely operating the vehicle in a variety of situations as the environment around the vehicle changes. While such monitoring systems have been used to asses the operation of the vehicle or whether a driver has changed or failed to change the operation of the vehicle in response to a detected event, current solutions do not assess the attention of the passenger to an object outside the vehicle. As discussed in more detail below, the instant disclosure provides a system for monitoring and assessing the attention of the passenger to an external object (e.g., a road sign) that may be within the field of view of the passenger in a vehicle. The system may calculate the duration of the passenger's attention and combine it with other data to generate a score for object's ability to maintain the attention of the passenger, which may be useful for rating a sign's effectiveness in, for example, communicating road information to the passenger or communicating an advertisement to the passenger.

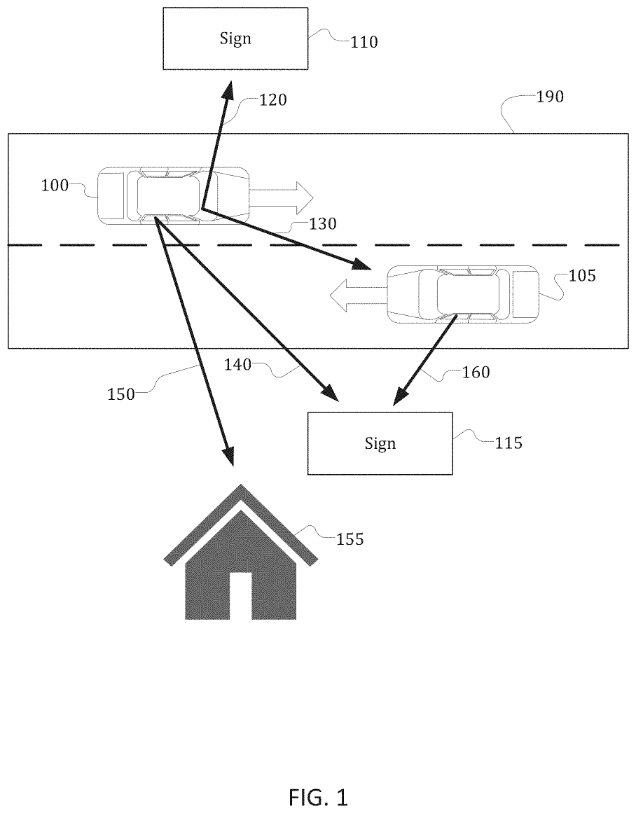

FIG. 1 illustrates an example of how passenger(s) in vehicle(s) may pay attention to various objects outside the vehicle. As shown in FIG. 1, vehicle 100 may be traveling from left to right along road 190. Vehicle 105 may be traveling from right to left along road 190. As the vehicles travel along road 190, various objects may be in the field of view of the passengers and attract the attention of a passenger or passengers in each vehicle. For example, sign 110 and sign 115 that are proximate the road 190 may be within the field of view of (e.g., visible to) the passenger(s) in vehicle 100 and/or 105 and draw the attention of the passenger (e.g., become the focus point of the passenger's attention). Objects further afield, such as house 155 or a beautiful landscape (not shown) may also draw the attention of the passenger(s) as it moves in and out of the passenger's field of view. In addition, other vehicles that are traveling along the road and enter the passenger's field of view may draw the attention of the passenger(s). For example, vehicle 105 may draw the attention of passengers in vehicle 100, and likewise, vehicle 100 may draw the attention of passengers in vehicle 105.

At any given moment in time, passenger(s) in the vehicle(s) may focus their attention on any of the external objects. The focus point of the passenger(s) is depicted in FIG. 1 by focus arrows 120, 130, 140, 150, and 160. For example, the passenger(s) may hold their focus point on an external objects for a certain amount of time, may refocus their attention on an external object a number of times after changing their focus point to other object(s), or certain objects may never be the focus point of the passenger (e.g., even though an object may be within the field of view of the passenger, it may never or only minimally hold the attention of the passenger). For example, a passenger in the driver's seat of vehicle 100 may at times focus his/her attention on sign 110, as indicated by focus arrow 120. At other times, the passenger in the driver's seat of vehicle 100 may focus his/her attention on passing vehicle 105, as indicated by focus arrow 130. Even though sign 115 may have passed within the field of view of the passenger in the driver's seat, for example, the driver may not have focused his/her attention on sign 115 or house 155. Similarly, a passenger located in the rear driver's side seat of vehicle 100 may at times focus his/her attention on passing sign 115, as indicated by focus arrow 140, or on house 155, as indicated by focus arrow 150. Even though sign 110 may have passed within the field of view of the passenger in the rear driver's side seat of vehicle 100, for example, the passenger may not have focused his/her attention on sign 110. As a further example, a passenger in the front passenger's seat of vehicle 105 may have focused his/her attention on sign 115, as indicated by focus arrow 160, and not on vehicle 100, sign 110, or house 155, even though they may have passed with his/her field of view.

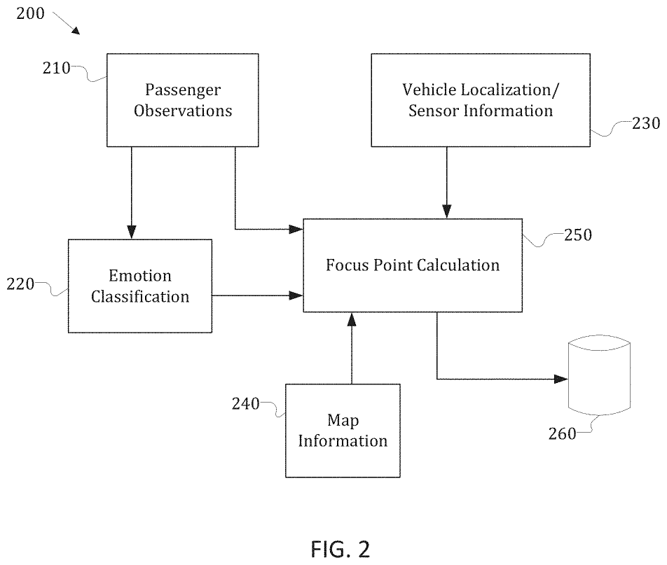

The system may use a number of inputs to determine the focus point of a passenger in a vehicle, as depicted in, for example, FIG. 2. Schematic 200 shows a system that may use a number of inputs, including passenger observations 210, emotion classification 220, vehicle localization/sensor information 230, and map information 240, to determine the focus point of a passenger and/or may be associated with focus point calculation 250.

For example, one input to focus point calculation 250 may include, at 210, observing an attribute of the passenger within the vehicle. The observed attributes may include, for example, the pose of the passenger's head, the direction in which the passenger's eyes are focused (gaze), the track/movement of the passenger's head (head track), the introduction of objects that may block the passenger's eyes/view, etc. In this regard, the system may observe the attributes of the passenger using any number of sensors or sensor information within the vehicle, including for example, a camera, a red-green-blue-depth sensor (RGB-D), a light detection and ranging (LiDAR) sensor, etc. The system may process the sensor information to track the observed attributes (e.g., the pose of the passenger's head and the focus point of the passenger's eyes) over a period of time. Based on this information, the system may estimate the field of view for the passenger to understand which objects may be currently visible to the passenger. From this, the system may determine a potential focus point on a given object within the field of view for a given point in time using, for example, a ray tracing algorithm that follows an estimated line of sight of the passenger to identify a particular object as the likely focus point of the passenger.

Another input to focus point calculation 250 may include, at 240, map information about known objects in the environment. Known objects in the environment may include, for example, signs (e.g., billboards, advertisements, traffic/road signs, traffic lights, etc.), points of interest (e.g., scenic buildings (e.g., castles, homes), famous buildings, monuments, hills/mountains, etc.), or other objects that may block or interfere with a passenger's field of view or focus point (e.g., railings/walls, bridges, large buildings, large trees, etc.). The map information may include the location, pose, height, shape, width, length, orientation, etc. of each known object. The focus point calculation 250 may use map information about known objects to determine a probabilities for a number of objects it estimates may be within the field of view of the passenger and which object may have the highest probability of being the focus point of the passenger.

In addition, depicted in 230, vehicle sensors that are capable of sensing information about the vehicle and detecting objects external to the vehicle may provide information to focus point calculation 250 to improve the accuracy of, to use in place of, and/or to supplement the map information. For example, the system may provide the information from cameras, positioning sensors, light detection and ranging (LiDAR) sensors, etc. that can sense information about the vehicle and detect external objects to focus point calculation 250 to improve the accuracy of the line of sight estimation. Vehicle localization/sensor information 230 may include the vehicle's external sensors which, similar to the map information 240, may detect objects in the environment such as signs (e.g., billboards, advertisements, traffic/road signs, traffic lights, etc.), buildings, or other objects that may be near the vehicle and draw the attention of the passenger or interfere with a passenger's field of view or focus point. For example, a large truck may pass in front of the passenger's line of sights, temporarily blocking the passenger's focus point such that the passenger may change his/her focus point until the large truck has passed. Thus, with this additional information, the system may update the field of view and focus point estimates accordingly.

Vehicle localization/sensor information 230 may include details about the movement of the vehicle, obtained for example from monitoring the vehicle's actual operating state and/or from vehicle sensors that detect operating states and positions of the vehicle. Focus point calculation 250 may use this information when determining the field of view and estimating the focus point of the passenger. For example, focus point calculation 250 may use the absolute position of the vehicle to correlate the position of the vehicle to the map information discussed above. Likewise, focus point calculation 250 may use the movement of the vehicle to identify objects/events that may cause changes to the passenger's focus or may block or interrupt the line of sight of the passenger. For example, an object/sign that was directly in front of a vehicle's current trajectory may have had a high probability of being the focus point of the passenger, but if the vehicle's trajectory is detected to have turned away from the sign such that the sign is no longer directly in front of the vehicle's new trajectory, it now may be less likely that the object/sign is the focus point of the driver. Of course, the system may correlate this to other monitored inputs. For example, the track of the passenger's head and/or eyes (e.g., from passenger observation 210) may indicate that the passenger's head/eyes have followed a track that counteracts the turn of the vehicle (e.g., from vehicle localization/sensor information 230), perhaps indicating that the object/sign has remained the focus of the passenger throughout the turn. As another example, the system may correlate the vehicle's motion (e.g., from vehicle localization/sensor information 230) with map information (e.g., from map information 240) and/or external sensor information (e.g., from vehicle localization/sensor information 230) to determine if the vehicle's turn resulted in new objects of interest appearing in the passenger's view.

After focus point calculation 250 has determined the field of view (and the associated objects within that field of view), focus point calculation 250 may use the above-described information to determine a focus point of the passenger (e.g., which object within the field of view has the current attention of the passenger). Once focus point calculation 250 has determined a focus point, it measures the duration of the passenger's focus on the focus point. Of course, this means that focus point calculation 250 may monitor the above-described inputs (e.g., from 210, 230, and/or 240) over time to follow the focus point as the inputs change. For example, when the vehicle is in motion, the system may track the passenger's gaze and head over time to determine if the focus point has remained on a first object or whether the focus point has possibly shifted to a second object. In addition, when measuring the duration, the system may take into account events that may have caused the passenger's focus to change for a short period of time while the object was within the field of view of the passenger. In other words, while an object is within the field of view of the passenger, the duration determination may take into account that the passenger's focus on the object may not be continuous and instead may be intermittent and/or interrupted by the passenger shifting their focus from the first object to another location (e.g., to check their speed on the dashboard, to converse with a fellow passenger, to check their rear-view mirror, to follow a sound, etc.) for a certain amount of time, and then returning their focus to the original object.

Based on the determined duration, they system may determine an attention score (AS) for a given object, which it may calculate as follows:

$${AS}_{object} = max \{ \frac{1}{object \text{-} duration} {\sum }_{i} {P}_{i} \times {t}_{i} , 1.0 \}$$

In the exemplary formula above, the attention score may be a normalized sum over all times i that the given object was the focus point of the passenger for time tᵢ with a probability of Pᵢ. The normalization factor (object-duration) is the time required for a person to appreciate the object (e.g., consume the content of the object). Thus, for a road sign, for example, this may be the time it takes for a person to understand the meaning of the sign, and for a commercial sign, for example, this may be the time it takes for the person to understand what product is being advertised. The normalization factor (object-duration) may be a constant value that may depend on the extent of the content of the object (e.g. the complexity of the pictures on the sign, the amount of text on the sign, the duration (e.g., 15 seconds, 30 seconds) of an image sequence/video on the sign). The system may use the normalization to avoid scoring the object with a very low attention score, when for example, the vehicle spends a large amount of time waiting in a traffic jam or at a traffic light, where the duration of time that a given sign is the focus point may be low compared to the overall time the sign is within the field of view. Similarly, the system may use the normalization to avoid scoring an object with a low attention score because the vehicle was passing the object/sign at a high rate of speed such that it was the focus point of the passenger for only a fraction of the time normally required to consume the content of the sign. With a normalization factor applied, AS is an attention score between 0 (the sign was never the focus point of the passenger) and 1 (the sign was the focus point of the passenger for a sufficient amount of time to fully consume it).

The attention score may also be an average attention score, and the system may calculate the attention score for each passenger in a vehicle. Thus, the system may compute an average attention score as

$$\overline{AS} = \frac{AS}{n} ,$$

where n is the number of times the sign was the focus point of a given passenger while it was within the field of view of the passenger. If multiple passengers are in a vehicle, the system may compute an attention score (and/or an average attention score) per passenger.

As noted earlier, the focus point calculation 250 may use a ray-tracing algorithm that calculates a likely focus point based on the multiple inputs. The focus point calculation may be further improved with information about the expected behavior (e.g., expected response or expected focus point) of a passenger to a stimulus. For example, the system may build a dataset of expected responses from empirical data that record observed passenger's responses (e.g., focus points for a given head/eye movement, spontaneous pupil dilatation (focus, light variation), and blink rate, each under car dynamics (e.g., correlated to the motion of the vehicle) to stimuluses (e.g., external stimuli like traffic lights, direction signs, road edges, bike lanes, tunnels, etc.), to establish an expected response for the average driver (e.g., an experienced) driver. Then, the system may compare the monitored passenger observations (e.g., in 210) against these expected responses to further improve the estimation of the likely focus point of the passenger under the given constellation of inputs. The system may implement the dataset of expected responses as a supervised deep-neural-network and trained using known safe passengers and stimuli. For example, the system may train the neural network to arrive at the average expected behavior using passenger observations (e.g., head/eye movement, pupil dilatation, blink rate, etc.) of an experienced driver (e.g., a known safe driver) who approaches a curve in the road (e.g., the stimulus). Likewise, the system may train the neural network to arrive at the average expected behavior using passenger observations (e.g., head/eye movement, pupil dilatation, blink rate, etc.) of an experienced driver (e.g., a known safe driver) who approaches a sign along the road (e.g., the stimulus).

In addition, the system may use the dataset of expected responses to control an action of the vehicle if the expected behavior (e.g., the attention of the passenger) to an external stimulus falls below a threshold minimum level (e.g., a threshold attention level). For example, if, when a vehicle approaches a curve in the road and the passenger's head/eye movement, blink rate, or pupil dilation is below the expected response, the automated system may take control of the vehicle from the passenger in order to begin steering the vehicle along the curve. Likewise, if the vehicle approaches an advertising sign along the side of the road and the passenger's head/eye movement, blink rate, or pupil dilation is below the expected response to the advertising sign, the automated system may slow the vehicle so that the passenger has a greater likelihood of focusing on the sign and fully consuming its content.

In addition to calculating the attention score for an object/sign (e.g., as part of focus point calculation 250), the system may determine an emotional reaction of the passenger to the object/sign (e.g., in emotional classification 220) and associated with the focus point calculation and attention score (e.g., provided to focus point calculation 250). For example, the system may base the emotional reaction of the passenger associated with the sign on any number of observed attributes of the passenger (e.g., from passenger observations 210), including, for example a facial expression, a gesture, a change in facial expression, and/or a change in gesture of the passenger. The system may classify the emotional reaction associated with an object/sign with a number of classifications, including happiness, sadness, annoyance, pleasure, displeasure, indifference, etc.

The system may use the attention score and/or emotional reaction for safety purposes and/or for advertisement purposes (e.g., to automatically reroute the vehicle or suggest a particular destination for the vehicle). For example, the vehicle may use the attention score and/or emotional reaction to suggest a safer road (e.g. a slower road or less distractions) for a driver who gives a high attention score to external signs, or to suggest as a destination for the vehicle (e.g., a business location associated with a sign that received a particularly high attention score from a passenger of the vehicle). The system may base the suggestion on, for example, whether the attention score and/or emotional reaction of the passenger to a particular sign meets a predefined threshold (e.g. a minimum amount of attention and/or a particular emotional classification).

The system may store the attention score, emotional reaction, and/or other information associated therewith as attention impact information in a database (e.g., in database 260 of FIG. 2) that may maintain attention scores for a number of objects/signs. In addition, the system may enhance a stored attention impact information associated with a given object/sign with additional information about the passenger who is associated with the attention impact information. For example, the system may store the age, gender, dress-code, or any other observed attribute of the passenger with a given attention score. Of course, the system may correlate the stored data with personal information and/or anonymize the data (e.g., in compliance with data privacy rules so that personal information is appropriate protected).

The system may associate the stored attention impact information with the geographic location of the vehicle at the time the attention score and emotional reaction was recorded, which the system may correlate to map information about the geographic location of the object/sign. In this manner, the system may aggregate, map, and/or average the attention impact information from many vehicles and many passengers for a given geographic location over a number of passengers/vehicles. For example, the system may cluster the aggregated attention impact information for a number of objects/signs in a geographic location into grid cells of a map, where each cell may contain an attention score (e.g., a cell attention score) for the objects/signs at that cell location. The system may compute the cell attention score (CAS) in each cell (i,j) (e.g., for row i and column j of a grid) as follows:

$${CAS}_{i , j} = {\sum }_{objects \text{/} signs} [ \frac{1}{\# passengers} {\sum }_{passengers} {AS}_{object \text{/} sign} ]$$

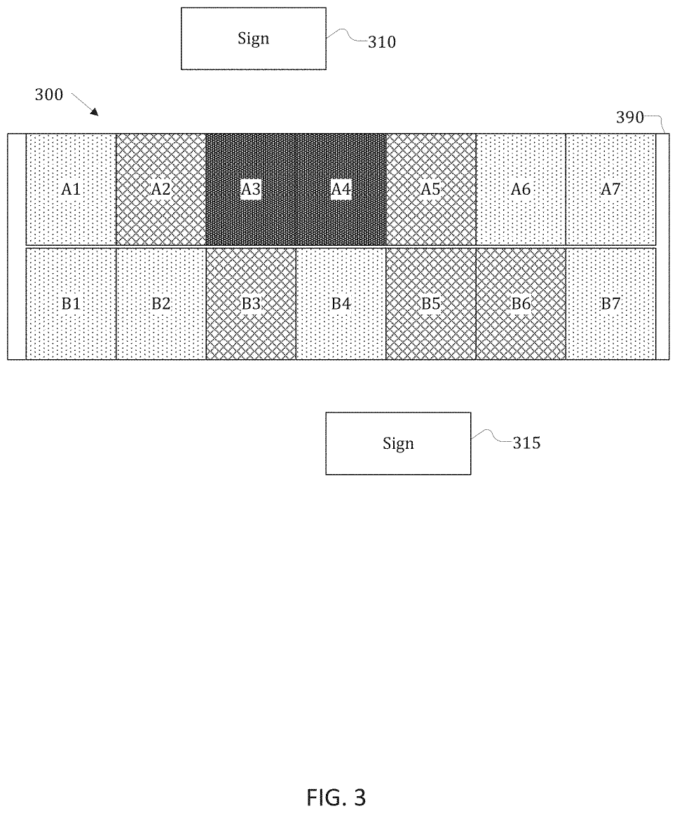

FIG. 3 depicts an exemplary grid map 300 that shows how the system may associate aggregated attention impact information with map data to provide cell attention scores for the objects/signs at a given geographic location. As shown in FIG. 3, sign 310 and sign 315 are located along road 390. Road 390 is divided into a grid of cells (A1-A7 and B1-B7) comprised of two rows (A and B), each with seven columns (1-7). The cell attention score has been shaded with lighter or darker patterns to graphically depict the relative weight of the attention score for each cell. Thus, cells A1, A6, A7, B1, B2, B4, and B7 have a relatively low attention score, so they are lightly shaded, whereas cells A3 and A4 have a relatively high attention score, so they are darkly shaded. Cells A2, A5, B3, B5, and B6 have a medium attention score, so they are neutrally shaded. The individual attention scores for each cell represents the total time the signs (e.g., sign 310 and/or sign 315) have been the focus point of passengers within a specific grid cell.

This type of grip map may be useful for safety authorities and/or for advertising companies to find the optimal location for a road sign or a commercial sign, or to balance the need for attention to road signs while minimizing distractions of commercial signs. In this regard, the system may use such a grid map in combination with traffic regulation maps, whereby safety authorities might identify locations where certain signs create a relatively high attention score (e.g. a billboard that frequently distract drivers from their driving task), and thus identify where safety rules might be added or adapted (e.g., a lower speed limit, additional traffic control devices, requiring billboards to be further from the road, etc.) to improve road safety. Additionally, advertising companies might use such a grid map to identify optimum areas for their billboards, or adjust pricing depending on the location or attention score. Additionally, mobility-as-a-service vehicles (such as busses, trams, taxis, ride-sharing vehicles, etc.) may use such a grid map to drive at a different speed (e.g., slower) through certain grid locations to enhance the likelihood that a passenger will view an object/sign at a particular grid location (e.g., at a grid location with a relatively low attention score).

As discussed above with respect to FIG. 2, the attention score of the passenger is derived from any of a number of passenger observations 210 that the system may monitor to assist in determining the field of view and focus point of the passenger. In addition to the examples of passenger observations (e.g., observed attributes) discussed above, the system may make any number of other passenger observations or observed attributes about the passenger. For example, information about the face of the passenger, the apparel worn by the passenger, objects carried/held by the passenger, gestures of the passenger, and/or a location of the passenger within the vehicle may be a passenger observation that the system monitors and/or records.

Under these larger categories of passenger observations, the system may determine more detailed observations about the passenger. For example, observed face information may include observations that are indicative of the skin color of the passenger, the gender of the passenger, the age of the passenger, the hair color of the passenger, and/or the hair style of the passenger. As another example, the observed apparel information may include observations that are indicative of the category of the apparel (e.g., casual, business, swimming, and/or outdoor) worn by the passenger. As another example, the observed information about objects carried or held by the passenger may include observations that are indicative of a mobile phone, sports equipment (e.g. skateboards, surfboards, roller skates, bikes, etc.) and/or a walking stick of the passenger. As another example, the gesture information may include observations indicative of a relationship status or marital status (e.g., a public display of affection may be indicative of a relationship) of the passenger and/or a social status of the passenger (e.g., a crowd of onlookers may be indicative of a popular person). The system may then correlate a collection of such passenger observations from many passengers with advertisement types and store the information in a database that the system may use to estimate what types of advertisements may be of interest to a given passenger.

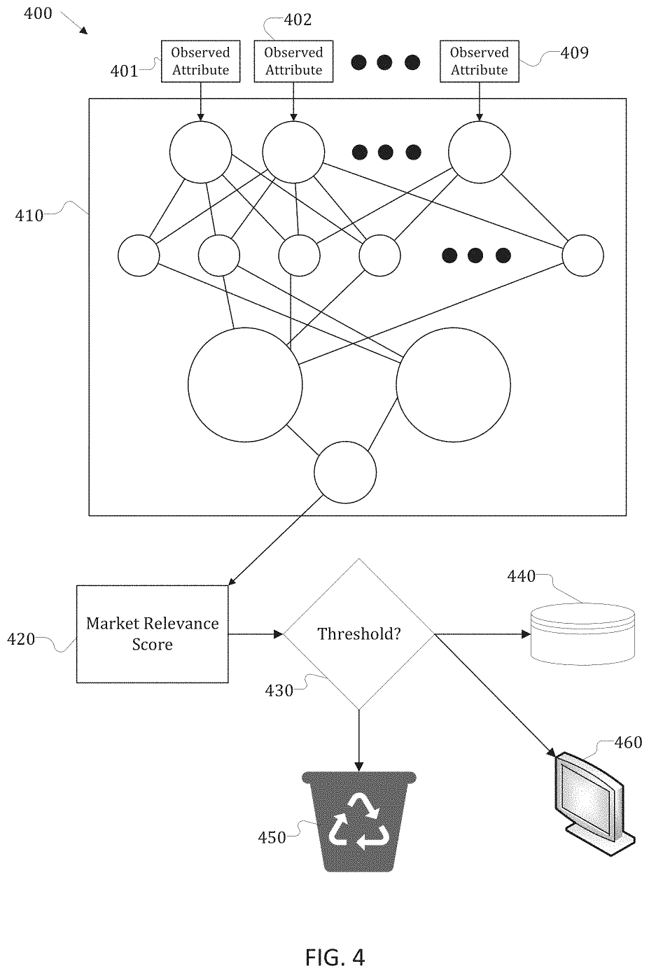

Given the large amount of information that the system may potentially observe about a passenger, the system need not store every observation of every passenger. Instead, the system may use a feature analyzer to estimate the market relevance of a particular observation and record the observation if the market relevance score exceeds a threshold level. FIG. 4 shows an exemplary feature analyzer 400 that the system may use to identify which observed attributes might be worth storing. At shown at the top of FIG. 4, the system may evaluate any number of observed attributes (e.g., observed attributes 401, 402, . . . 409) to obtain a market relevance score 420. The observed attributes (e.g., observed attributes 401, 402, . . . 409) may be the inputs to a market relevance modeling function 410 that outputs the market relevance score 420. The market relevance modeling function 410 may consider the various combinations and permutations of the input variables in order to arrive at the market relevance score 420. The market relevance modeling function 410 may be a regression deep neural network (DNN) that maps a multi-dimensional input vector (e.g., observed attributes 401, 402, . . . 409) to a scalar value (e.g., the market relevance score 420).

For example, the multi-dimensional input vector of the market relevance modeling function 410 may take into account a combination of passenger observations that result in a high market relevance score, because a single passenger observation may not have a particularly high market relevance score. For example, observing that a passenger is between 20 to 30 years old may not provide sufficient market relevance to target any particular advertisement. However, observing that the passenger also wears formal apparel, has a smartphone, is wearing headphones, and has been riding in the vehicle for about 30 minutes (e.g., a typical work-home commute time), there may be a higher market relevance score (e.g., the passenger may be a young professional with a good education, high fixed salary, and at a stable job such that advertisements related to mortgage, expensive watches, credit cards, sporty vehicles, etc. might be of particular relevance).

Once the system determines the market relevance score 420, the system may compare it against a threshold relevance 430 to determine whether the observation may be worth saving (e.g., in database 440) or whether it may be discarded (e.g., in trashcan/recycler 450). The system may adjust the threshold relevance 430 to set the sensitivity of the feature analyzer (i.e., a higher threshold results in recording fewer observations while a lower threshold results in recording more observations). In addition, if the market relevance score 420 exceeds the threshold relevance 430, the system may display, based on the observation, a targeted advertisement on a screen/display 460 that may be visible to the passenger.

As noted earlier, the system may take passenger observations of many passengers within the vehicle, and the vehicle may also include larger transportation vehicles, such as trains, trams, subways, buses, airport people-movers, rides-sharing vehicles, taxis, etc. In vehicles where passengers may move in and out of the vehicle (e.g., at scheduled stops) or around the vehicle (e.g., in a train when a once-occupied seat becomes available), it may be important for the system to track the passenger's movement, including when the passenger enters the transportation vehicle, when the passenger is on the vehicle, and when the passenger exits the vehicle. To correctly count the number of passengers and to avoid duplicate observations of the same individual, the system may assign a unique identifier to a given passenger so that the system may associate the observations with a particular passenger. To accomplish this, the system may track each passenger's face/body location during the ride in the transportation vehicle, using conventional approaches, such as, for example, Kalman filters.

If the market relevance modeling function 410 is a regression deep neural network (DNN), the system may initially train the weights of the DNN with a dataset of market value dependencies extracted, for example, from randomly selected, current product advertisements. The system may create labels for such a training dataset by verifying to what degree a specific passenger observation (e.g. age, hair style, carried objects, etc.) is relevant for a given advertisement and then assigning it a proportional value. Such a training dataset may also take into account market analysis data for popular products. It should be appreciated that the system may retrain the weights of the DNN at any time, especially when factors influencing the market relevance may change (e.g. an important new trend emerges). It should also be appreciated that the system may adjust or train the network weights based on specific target parameters. For example, a skateboard vendor who is interested in obtaining the recorded observations might want to place a higher weight on certain observations (e.g., wearing sports apparel and carrying sports equipment) so that such observations may result in a higher market relevance score.

Because the passenger observations may impact privacy issues, the system may encrypt the database and might use privacy-aware post-processing to avoid storing privacy-protected information that might be associated with a particular individual. The privacy-aware post-processing may store the observations in a buffer database (e.g., temporary memory) until observations have been stored for a threshold number of individuals. Only after the threshold number of individuals has been met, the system may then store the observations in the database (e.g., permanent memory). In addition, the privacy-aware post-processing may buffer the data for a particular time interval. The system (or a user of the system) may chose the time interval based on a typical trip length (e.g., a multiple of the typical trip length). The purpose of the buffer database and/or time interval is to minimize the risk of a possible one-to-one correspondence of a database entry with a specific individual.

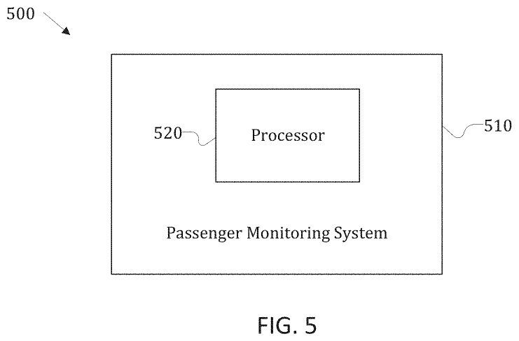

FIG. 5 is a schematic drawing illustrating a device 500 for monitoring passengers in a vehicle. The device 500 may include any of the features described above. FIG. 5 may be implemented as an apparatus, a method, and/or a computer readable medium that, when executed, performs the features described above. It should be understood that device 500 is only an example, and other configurations may be possible that include, for example, different components or additional components.

Device 500 includes a passenger monitoring system 510. The passenger monitoring system 510 includes a processor 520. In addition or in combination with any of the features described in the following paragraphs, the processor 520 of passenger monitoring system 510 is configured to monitor an observed attribute of a passenger in a vehicle, wherein the observed attribute includes a gaze of the passenger and a head track of the passenger. The processor 520 is also configured to determine a field of view of the passenger based on the observed attribute. The processor 520 is also configured to determine a focus point of the passenger within field of view based on the observed attribute. The processor 520 is also configured to determine whether a sign is within the field of view of the passenger. The processor 520 is also configured to record an attention score for the sign based on a duration of time during which the sign is within the field of view and estimated to be the focus point of the passenger.

Furthermore, in addition to or in combination with any one of the features of this and/or the preceding paragraph with respect to passenger monitoring system 510, the processor 520 may be further configured to determine for the duration of time an emotional reaction of the passenger associated with the sign. Furthermore, in addition to or in combination with any one of the features of this and/or the preceding paragraph with respect to passenger monitoring system 510, the emotional reaction of the passenger associated with the sign may be based on the observed attribute and/or at least one of a facial expression, a gesture, a change in facial expression, and/or a change in gesture of the passenger. Furthermore, in addition to or in combination with any one of the features of this and/or the preceding paragraph with respect to passenger monitoring system 510, the processor 520 may be further configured to classify the emotional reaction as at least one of a plurality of emotion classifications, wherein the plurality of emotion classifications include happiness, sadness, annoyance, pleasure, displeasure, and/or indifference. Furthermore, in addition to or in combination with any one of the features of this and/or the preceding paragraph with respect to passenger monitoring system 510, the field of view of the passenger may be determined at a map location associated with a geographic location of the vehicle.

Furthermore, in addition to or in combination with any one of the features of this and/or the preceding two paragraphs with respect to passenger monitoring system 510, the duration of time may include a sum of a plurality of separate times during which the sign was estimated to be the focus point of the passenger. Furthermore, in addition to or in combination with any one of the features of this and/or the preceding two paragraphs with respect to passenger monitoring system 510, the attention score may include a normalization factor that corresponds to an expected time required to appreciate the sign. Furthermore, in addition to or in combination with any one of the features of this and/or the preceding two paragraphs with respect to passenger monitoring system 510, the normalization factor may include a constant value based on an extent of content in the sign. Furthermore, in addition to or in combination with any one of the features of this and/or the preceding two paragraphs with respect to passenger monitoring system 510, determining whether the sign is within the field of view may include receiving sign object information associated with the geographic location of the vehicle from a map database containing sign object information for a plurality of signs at the geographic location. Furthermore, in addition to or in combination with any one of the features of this and/or the preceding two paragraphs with respect to passenger monitoring system 510, the sign object information may include at least one of a position, a pose, a height, a shape, a width, a length, and/or an orientation of the sign. Furthermore, in addition to or in combination with any one of the features of this and/or the preceding two paragraphs with respect to passenger monitoring system 510, the map database may include focal point information at the geographic location, wherein the focal point information may include at least one of point of interest information, traffic control device information, and obstacle information at the geographic location, and wherein determining the focus point of the passenger further depends on the focal point information.

Furthermore, in addition to or in combination with any one of the features of this and/or the preceding three paragraphs with respect to passenger monitoring system 510, wherein determining the focus point of the passenger may be based on a first probability associated with the focal point information and a second probability associated with the sign. Furthermore, in addition to or in combination with any one of the features of this and/or the preceding three paragraphs with respect to passenger monitoring system 510, the processor 520 may be further configured to store the classified emotional reaction with the attention score as stored attention impact information in a database. Furthermore, in addition to or in combination with any one of the features of this and/or the preceding three paragraphs with respect to passenger monitoring system 510, the stored attention impact information may include a map location associated with a geographic location of the vehicle. Furthermore, in addition to or in combination with any one of the features of this and/or the preceding three paragraphs with respect to passenger monitoring system 510, the observed attribute may include a plurality of observed attributes of the passenger and the stored attention impact information may include the plurality of observed attributes of the passenger, and the the plurality of observed attributes may include at least one of an age, a gender, and/or a dress-code of the passenger, and the stored attention impact information may be anonymized. Furthermore, in addition to or in combination with any one of the features of this and/or the preceding three paragraphs with respect to passenger monitoring system 510, the database may include a plurality of stored attention impact information received from a plurality of other vehicles at a plurality of map locations.

Furthermore, in addition to or in combination with any one of the features of this and/or the preceding four paragraphs with respect to passenger monitoring system 510, the processor 520 may be further configured to determine an average driver distraction time for each of the plurality of map locations based on the plurality of stored attention impact information received from the plurality of other vehicles. Furthermore, in addition to or in combination with any one of the features of this and/or the preceding four paragraphs with respect to passenger monitoring system 510, monitoring the observed attribute may include using sensor information from the vehicle, wherein the sensor information may include at least one of camera information, LiDAR information, and/or depth sensor information. Furthermore, in addition to or in combination with any one of the features of this and/or the preceding four paragraphs with respect to passenger monitoring system 510, the gaze and the head track may be determined based on a pose of the head of the passenger and a focus point of the eyes of the passenger. Furthermore, in addition to or in combination with any one of the features of this and/or the preceding four paragraphs with respect to passenger monitoring system 510, the processor 520 may be configured to suggest a destination for the vehicle based on the attention score and a business location associated with the sign. Furthermore, in addition to or in combination with any one of the features of this and/or the preceding four paragraphs with respect to passenger monitoring system 510, determining the focus point of the passenger may be based on an expected focus point of the passenger.

Furthermore, in addition to or in combination with any one of the features of this and/or the preceding five paragraphs with respect to passenger monitoring system 510, the expected focus point may be determined based on an expected response of the passenger to a stimulus. Furthermore, in addition to or in combination with any one of the features of this and/or the preceding five paragraphs with respect to passenger monitoring system 510, the stimulus may include a stimulus external to the vehicle and/or a synthetic visual stimulus internal to the vehicle. Furthermore, in addition to or in combination with any one of the features of this and/or the preceding five paragraphs with respect to passenger monitoring system 510, the stimulus may include the sign. Furthermore, in addition to or in combination with any one of the features of this and/or the preceding five paragraphs with respect to passenger monitoring system 510, the stimulus may be associated with map data based on a geographic location of the vehicle. Furthermore, in addition to or in combination with any one of the features of this and/or the preceding five paragraphs with respect to passenger monitoring system 510, the expected response may be based on information associated with an average response of experienced drivers to the stimulus, wherein the expected response may correspond to at least one of an expected gaze, an expected head track, an expected pupil dilation, and/or an expected blink rate. Furthermore, in addition to or in combination with any one of the features of this and/or the preceding five paragraphs with respect to passenger monitoring system 510, the expected response may depend on a motion of the vehicle.

Furthermore, in addition to or in combination with any one of the features of this and/or the preceding six paragraphs with respect to passenger monitoring system 510, the processor 520 may be further configured to determine an attention level of the passenger based on a difference between the focus point of the passenger and the expected response, and further configured to take an action depending on whether the attention level falls below a threshold attention level. Furthermore, in addition to or in combination with any one of the features of this and/or the preceding six paragraphs with respect to passenger monitoring system 510, the expected response is trained using a supervised deep-neural-network system. Furthermore, in addition to or in combination with any one of the features of this and/or the preceding six paragraphs with respect to passenger monitoring system 510, the observed attribute of the passenger may include at least one of a face information associated with a face of the passenger, apparel information associated with an apparel worn by the passenger, object information associated with an object of the passenger, gesture information associated with a gesture of the passenger, and/or a location of the passenger within the vehicle. Furthermore, in addition to or in combination with any one of the features of this and/or the preceding six paragraphs with respect to passenger monitoring system 510, the face information may be indicative of at least one of a skin color of the passenger, a gender of the passenger, an age of the passenger, a hair color of the passenger, and/or a hair style of the passenger. Furthermore, in addition to or in combination with any one of the features of this and/or the preceding six paragraphs with respect to passenger monitoring system 510, the apparel information may be indicative of an apparel category that may include at least one of casual, business, swimming, and/or outdoor. Furthermore, in addition to or in combination with any one of the features of this and/or the preceding six paragraphs with respect to passenger monitoring system 510, the object information may be indicative of at least one of a phone, a sports equipment, and/or a walking stick. Furthermore, in addition to or in combination with any one of the features of this and/or the preceding six paragraphs with respect to passenger monitoring system 510, the gesture information may be indicative of at least one of a marital status of the passenger and/or a social status of the passenger.

Furthermore, in addition to or in combination with any one of the features of this and/or the preceding seven paragraphs with respect to passenger monitoring system 510, the processor 520 may be further configured to analyze the observed attribute to estimate a market relevance score of the observed attribute in relation to a targeted advertisement, determine whether the market relevance score exceeds a threshold relevance, and if the market relevance score exceeds the threshold relevance, store the observed attribute and the market relevance score associated with the targeted advertisement in a market analysis database. Furthermore, in addition to or in combination with any one of the features of this and/or the preceding seven paragraphs with respect to passenger monitoring system 510, the observed attribute may include a plurality of observed attributes and wherein the market relevance score is determined based on a deep neural network that uses the plurality of observed attributes as input vectors. Furthermore, in addition to or in combination with any one of the features of this and/or the preceding seven paragraphs with respect to passenger monitoring system 510, the processor 520 may be further configured to train the deep neural network using a dataset of known market value dependencies for product advertisements that relates a weight of each of the plurality of observed attributes to the market relevance score. Furthermore, in addition to or in combination with any one of the features of this and/or the preceding seven paragraphs with respect to passenger monitoring system 510, the processor 520 may be further configured to update the dataset by changing the weight of at least one of the plurality of observed attributes based on a change in the market relevance score of the observed attribute.

Furthermore, in addition to or in combination with any one of the features of this and/or the preceding eight paragraphs with respect to passenger monitoring system 510, the processor 520 may be further configured to display to the passenger a selected advertisement that is selected based on information from the market analysis database and the observed attribute of the passenger. Furthermore, in addition to or in combination with any one of the features of this and/or the preceding eight paragraphs with respect to passenger monitoring system 510, the observed attribute and the market relevance score may include a plurality of observed attributes and a plurality of market relevance scores associated with a number of individuals, and before storing the plurality of observed attributes and the plurality of market relevance scores in the market analysis database, storing the plurality of observed attributes and the plurality of market relevance scores in a buffering database, and only if the number of individuals exceeds a threshold number of individuals, storing the plurality of observed attributes and the plurality of market relevance scores in the market analysis database. Furthermore, in addition to or in combination with any one of the features of this and/or the preceding eight paragraphs with respect to passenger monitoring system 510, the threshold number of individuals may depend on a time interval during which the observed attribute and the market relevance are collected in the buffering database.

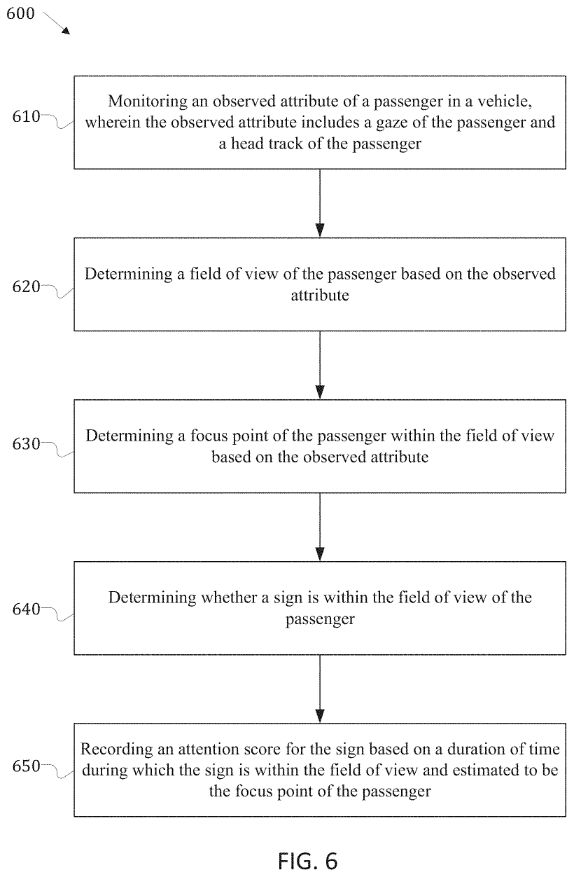

FIG. 6 depicts a schematic flow diagram of a method 600 for monitoring a passenger in a vehicle. Method 600 may implement any of the features described above with respect to device 500.

Method 600 for monitoring a passenger in a vehicle includes, in 610, monitoring an observed attribute of a passenger in a vehicle, wherein the observed attribute includes a gaze of the passenger and a head track of the passenger. Method 600 also includes, in 620, determining a field of view of the passenger based on the observed attribute. Method 600 also includes, in 630, determining a focus point of the passenger within field of view based on the observed attribute. Method 600 also includes, in 640, determining whether a sign is within the field of view of the passenger. Method 600 also includes, in 650, recording an attention score for the sign based on a duration of time during which the sign is within the field of view and estimated to be the focus point of the passenger.

Example 1 is a passenger monitoring system including a processor configured to monitor an observed attribute of a passenger in a vehicle, wherein the observed attribute includes a gaze of the passenger and a head track of the passenger. The processor is also configured to determine a field of view of the passenger based on the observed attribute. The processor is also configured to determine a focus point of the passenger within field of view based on the observed attribute. The processor is also configured to determine whether a sign is within the field of view of the passenger. The processor is also configured to record an attention score for the sign based on a duration of time during which the sign is within the field of view and estimated to be the focus point of the passenger.

Example 2 is the passenger monitoring system of Example 1, wherein the processor is further configured to determine for the duration of time an emotional reaction of the passenger associated with the sign.

Example 3 is the passenger monitoring system of Example 2, wherein the emotional reaction of the passenger associated with the sign is based on at least one of the observed attribute, a facial expression, a gesture, a change in facial expression, and/or a change in gesture of the passenger.

Example 4 is the passenger monitoring system of either Examples 2 or 3, wherein the processor is further configured to classify the emotional reaction as at least one of a plurality of emotion classifications, wherein the plurality of emotion classifications include happiness, sadness, annoyance, pleasure, displeasure, and/or exampleifference.

Example 5 is the passenger monitoring system of any one of Examples 1 to 4, wherein the field of view of the passenger is determined at a map location associated with a geographic location of the vehicle.

Example 6 is the passenger monitoring system of any one of Examples 1 to 5, wherein the duration of time includes a sum of a plurality of separate times during which the sign was estimated to be the focus point of the passenger.

Example 7 is the passenger monitoring system of any one of Examples 1 to 6, wherein the attention score includes a normalization factor that corresponds to an expected time required to appreciate the sign.

Example 8 is the passenger monitoring system of Example 7, wherein the normalization factor includes a constant value based on an extent of content in the sign.

Example 9 is the passenger monitoring system of any one of Examples 5 to 8, wherein determining whether the sign is within the field of view includes receiving sign object information associated with the geographic location of the vehicle from a map database containing sign object information for a plurality of signs at the geographic location.

Example 10 is the passenger monitoring system of Example 9, wherein the sign object information includes at least one of a position, a pose, a height, a shape, a width, a length, and/or an orientation of the sign.

Example 11 is the passenger monitoring system of either Examples 9 or 10, wherein the map database further contains focal point information at the geographic location, wherein the focal point information includes at least one of point of interest information, traffic control device information, and obstacle information at the geographic location, and wherein determining the focus point of the passenger further depends on the focal point information.

Example 12 is the passenger monitoring system of Example 11, wherein determining the focus point of the passenger is further based on a first probability associated with the focal point information and a second probability associated with the sign.

Example 13 is the passenger monitoring system of any one of Examples 4 to 12, wherein the processor is further configured to store the classified emotional reaction with the attention score as stored attention impact information in a database.

Example 14 is the passenger monitoring system of Example 13, wherein the stored attention impact information further includes the map location associated with the geographic location of the vehicle.

Example 15 is the passenger monitoring system of either Examples 13 or 14, wherein the observed attribute includes a plurality of observed attributes of the passenger, wherein the stored attention impact information includes the plurality of observed attributes of the passenger, wherein the plurality of observed attributes include at least one of an age, a gender, and/or a dress-code of the passenger, and wherein the stored attention impact information is anonymized.

Example 16 is the passenger monitoring system of any one of Examples 13 to 15, wherein the database further includes a plurality of stored attention impact information received from a plurality of other vehicles at a plurality of map locations.

Example 17 is the passenger monitoring system of Example 16, wherein the processor is further configured to determine an average driver distraction time for each of the plurality of map locations based on the plurality of stored attention impact information received from the plurality of other vehicles.

Example 18 is the passenger monitoring system of any one of Examples 1 to 17, wherein monitoring the observed attributed includes using sensor information from the vehicle, wherein the sensor information includes at least one of camera information, LiDAR information, and/or depth sensor information.

Example 19 is the passenger monitoring system of any one of Examples 1 to 18, wherein the gaze and the head track are determined based on a pose of the head of the passenger and a focus point of the eyes of the passenger.

Example 20 is the passenger monitoring system of any one of Examples 1 to 19, wherein the processor is further configured to suggest a destination for the vehicle based on the attention score and a business location associated with the sign.

Example 21 is the passenger monitoring system of any one of Examples 1 to 20, wherein determining the focus point of the passenger is further based on an expected focus point of the passenger.

Example 22 is the passenger monitoring system of Example 21, wherein the expected focus point is determined based on an expected response of the passenger to a stimulus.

Example 23 is the passenger monitoring system of Example 22, wherein the stimulus includes a stimulus external to the vehicle and/or a synthetic visual stimulus internal to the vehicle.

Example 24 is the passenger monitoring system of either Examples 22 or 23, wherein the stimulus includes the sign.

Example 25 is the passenger monitoring system of any one of Examples 22 to 24, wherein the stimulus is associated with map data based on a geographic location of the vehicle.

Example 26 is the passenger monitoring system of any one of Examples 22 to 25, wherein the expected response is based on information associated with an average response of experienced drivers to the stimulus, wherein the expected response corresponds to at least one of an expected gaze, an expected head track, an expected pupil dilation, and/or an expected blink rate.

Example 27 is the passenger monitoring system of any one of Examples 22 to 26, wherein the expected response depends on a motion of the vehicle.

Example 28 is the passenger monitoring system of any one of Examples 22 to 27, wherein the processor is further configured to determine an attention level of the passenger based on a difference between the focus point of the passenger and the expected response. The processor is also configured to take an action depending on whether the attention level falls below a threshold attention level.

Example 29 is the passenger monitoring system of any one of Examples 22 to 28, wherein the expected response is trained using a supervised deep-neural-network system.

Example 30 is the passenger monitoring system of any one of Examples 1 to 29, wherein the observed attribute of the passenger further includes at least one of a face information associated with a face of the passenger, apparel information associated with an apparel worn by the passenger, object information associated with an object of the passenger, gesture information associated with a gesture of the passenger, and/or a location of the passenger within the vehicle.

Example 31 is the passenger monitoring system of Example 30, wherein the face information is indicative of at least one of a skin color of the passenger, a gender of the passenger, an age of the passenger, a hair color of the passenger, and/or a hair style of the passenger.

Example 32 is the passenger monitoring system of either Examples 30 or 31, wherein the apparel information is indicative of an apparel category including at least one of casual, business, swimming, and/or outdoor.

Example 33 is the passenger monitoring system of any one of Examples 30 to 32, wherein the object information is indicative of at least one of a phone, a sports equipment, and/or a walking stick.

Example 34 is the passenger monitoring system of any one of Examples 30 to 33, wherein the gesture information is indicative of at least one of a marital status of the passenger and/or a social status of the passenger.

Example 35 is the passenger monitoring system of any one of Examples 30 to 34, wherein the processor is further configured to analyze the observed attribute to estimate a market relevance score of the observed attribute in relation to a targeted advertisement. The processor is also configured to determine whether the market relevance score exceeds a threshold relevance, and if the market relevance score exceeds the threshold relevance. The processor is also configured to store the observed attribute and the market relevance score associated with the targeted advertisement in a market analysis database.

Example 36 is the passenger monitoring system of Example 35, wherein the observed attribute includes a plurality of observed attributes and wherein the market relevance score is determined based on a deep neural network that uses the plurality of observed attributes as input vectors.

Example 37 is the passenger monitoring system of Example 36, wherein the processor is further configured to train the deep neural network using a dataset of known market value dependencies for product advertisements that relates a weight of each of the plurality of observed attributes to the market relevance score.

Example 38 is the passenger monitoring system of Example 37, wherein the processor is further configured to update the dataset by changing the weight of at least one of the plurality of observed attributes based on a change in the market relevance score of the observed attribute.

Example 39 is the passenger monitoring system of any one of Examples 35 to 38, wherein the processor is further configured to display to the passenger a selected advertisement that is selected based on information from the market analysis database and the observed attribute of the passenger.

Example 40 is the passenger monitoring system of any one of Examples 35 to 39, wherein the observed attribute and the market relevance score include a plurality of observed attributes and a plurality of market relevance scores associated with a number of individuals, and before storing the plurality of observed attributes and the plurality of market relevance scores in the market analysis database, storing the plurality of observed attributes and the plurality of market relevance scores in a buffering database, and only if the number of individuals exceeds a threshold number of individuals, storing the plurality of observed attributes and the plurality of market relevance scores in the market analysis database.

Example 41 is the passenger monitoring system of Example 40, wherein the threshold number of individuals depends on a time interval during which the observed attribute and the market relevance are collected in the buffering database.

Example 42 is a passenger monitoring device that includes a processor configured to monitor an observed attribute of a passenger in a vehicle, wherein the observed attribute includes a gaze of the passenger and a head track of the passenger. The processor is also configured to determine a field of view of the passenger based on the observed attribute. The processor is also configured to determine a focus point of the passenger within field of view based on the observed attribute. The processor is also configured to determine whether a sign is within the field of view of the passenger. The processor is also configured to record an attention score for the sign based on a duration of time during which the sign is within the field of view and estimated to be the focus point of the passenger.

Example 43 is the passenger monitoring device of Example 42, wherein the processor is further configured to determine for the duration of time an emotional reaction of the passenger associated with the sign.

Example 44 is the passenger monitoring device of Example 43, wherein the emotional reaction of the passenger associated with the sign is based on at least one of the observed attribute, a facial expression, a gesture, a change in facial expression, and/or a change in gesture of the passenger.

Example 45 is the passenger monitoring device of either Examples 43 or 44, wherein the processor is further configured to classify the emotional reaction as at least one of a plurality of emotion classifications, wherein the plurality of emotion classifications include happiness, sadness, annoyance, pleasure, displeasure, and/or exampleifference.

Example 46 is the passenger monitoring device of any one of Examples 42 to 45, wherein the field of view of the passenger is determined at a map location associated with a geographic location of the vehicle.

Example 47 is the passenger monitoring device of any one of Examples 42 to 46, wherein the duration of time includes a sum of a plurality of separate times during which the sign was estimated to be the focus point of the passenger.

Example 48 is the passenger monitoring device of any one of Examples 42 to 47, wherein the attention score includes a normalization factor that corresponds to an expected time required to appreciate the sign.

Example 49 is the passenger monitoring device of Example 48, wherein the normalization factor includes a constant value based on an extent of content in the sign.

Example 50 is the passenger monitoring device of any one of Examples 46 to 49, wherein determining whether the sign is within the field of view includes receiving sign object information associated with the geographic location of the vehicle from a map database containing sign object information for a plurality of signs at the geographic location.

Example 51 is the passenger monitoring device of Example 50, wherein the sign object information includes at least one of a position, a pose, a height, a shape, a width, a length, and/or an orientation of the sign.

Example 52 is the passenger monitoring device of either Examples 50 or 51, wherein the map database further contains focal point information at the geographic location, wherein the focal point information includes at least one of point of interest information, traffic control device information, and obstacle information at the geographic location, and wherein determining the focus point of the passenger further depends on the focal point information.

Example 53 is the passenger monitoring device of Example 52, wherein determining the focus point of the passenger is further based on a first probability associated with the focal point information and a second probability associated with the sign.

Example 54 is the passenger monitoring device of any one of Examples 45 to 53, wherein the processor is further configured to store the classified emotional reaction with the attention score as stored attention impact information in a database.

Example 55 is the passenger monitoring device of Example 54, wherein the stored attention impact information further includes the map location associated with the geographic location of the vehicle.

Example 56 is the passenger monitoring device of either Examples 54 or 55, wherein the observed attribute includes a plurality of observed attributes of the passenger, wherein the stored attention impact information includes the plurality of observed attributes of the passenger, wherein the plurality of observed attributes include at least one of an age, a gender, and/or a dress-code of the passenger, and wherein the stored attention impact information is anonymized.

Example 57 is the passenger monitoring device of any one of Examples 54 to 56, wherein the database further includes a plurality of stored attention impact information received from a plurality of other vehicles at a plurality of map locations.

Example 58 is the passenger monitoring device of Example 57, wherein the processor is further configured to determine an average driver distraction time for each of the plurality of map locations based on the plurality of stored attention impact information received from the plurality of other vehicles.

Example 59 is the passenger monitoring device of any one of Examples 42 to 58, wherein monitoring the observed attributed includes using sensor information from the vehicle, wherein the sensor information includes at least one of camera information, LiDAR information, and/or depth sensor information.

Example 60 is the passenger monitoring device of any one of Examples 42 to 59, wherein the gaze and the head track are determined based on a pose of the head of the passenger and a focus point of the eyes of the passenger.

Example 61 is the passenger monitoring device of any one of Examples 42 to 60, wherein the processor is further configured to suggest a destination for the vehicle based on the attention score and a business location associated with the sign.

Example 62 is the passenger monitoring device of any one of Examples 42 to 61, wherein determining the focus point of the passenger is further based on an expected focus point of the passenger.

Example 63 is the passenger monitoring device of Example 62, wherein the expected focus point is determined based on an expected response of the passenger to a stimulus.

Example 64 is the passenger monitoring device of Example 63, wherein the stimulus includes a stimulus external to the vehicle and/or a synthetic visual stimulus internal to the vehicle.

Example 65 is the passenger monitoring device of any one of Examples 63 or 64, wherein the stimulus includes the sign.

Example 66 is the passenger monitoring device of any one of Examples 63 to 65, wherein the stimulus is associated with map data based on a geographic location of the vehicle.

Example 67 is the passenger monitoring device of any one of Examples 63 to 66, wherein the expected response is based on information associated with an average response of experienced drivers to the stimulus, wherein the expected response corresponds to at least one of an expected gaze, an expected head track, an expected pupil dilation, and/or an expected blink rate.

Example 68 is the passenger monitoring device of any one of Examples 63 to 67, wherein the expected response depends on a motion of the vehicle.

Example 69 is the passenger monitoring device of any one of Examples 63 to 68, wherein the processor is further configured to determine an attention level of the passenger based on a difference between the focus point of the passenger and the expected response. The processor is also configured to take an action depending on whether the attention level falls below a threshold attention level.

Example 70 is the passenger monitoring device of any one of Examples 63 to 69, wherein the expected response is trained using a supervised deep-neural-network system.

Example 71 is the passenger monitoring device of any one of Examples 42 to 70, wherein the observed attribute of the passenger further includes at least one of a face information associated with a face of the passenger, apparel information associated with an apparel worn by the passenger, object information associated with an object of the passenger, gesture information associated with a gesture of the passenger, and/or a location of the passenger within the vehicle.

Example 72 is the passenger monitoring device of Example 71, wherein the face information is indicative of at least one of a skin color of the passenger, a gender of the passenger, an age of the passenger, a hair color of the passenger, and/or a hair style of the passenger.

Example 73 is the passenger monitoring device of either Examples 71 or 72, wherein the apparel information is indicative of an apparel category including at least one of casual, business, swimming, and/or outdoor.

Example 74 is the passenger monitoring device of any one of Examples 71 to 73, wherein the object information is indicative of at least one of a phone, a sports equipment, and/or a walking stick.

Example 75 is the passenger monitoring device of any one of Examples 71 to 74, wherein the gesture information is indicative of at least one of a marital status of the passenger and/or a social status of the passenger.

Example 76 is the passenger monitoring device of any one of Examples 71 to 75, wherein the processor is further configured to analyze the observed attribute to estimate a market relevance score of the observed attribute in relation to a targeted advertisement. The processor is also configured to determine whether the market relevance score exceeds a threshold relevance, and if the market relevance score exceeds the threshold relevance. The processor is also configured to store the observed attribute and the market relevance score associated with the targeted advertisement in a market analysis database.

Example 77 is the passenger monitoring device of Example 76, wherein the observed attribute includes a plurality of observed attributes and wherein the market relevance score is determined based on a deep neural network that uses the plurality of observed attributes as input vectors.

Example 78 is the passenger monitoring device of Example 77, wherein the processor is further configured to train the deep neural network using a dataset of known market value dependencies for product advertisements that relates a weight of each of the plurality of observed attributes to the market relevance score.

Example 79 is the passenger monitoring device of Example 78, wherein the processor is further configured to update the dataset by changing the weight of at least one of the plurality of observed attributes based on a change in the market relevance score of the observed attribute.

Example 80 is the passenger monitoring device of any one of Examples 76 to 79, wherein the processor is further configured to display to the passenger a selected advertisement that is selected based on information from the market analysis database and the observed attribute of the passenger.

Example 81 is the passenger monitoring device of any one of Examples 76 to 80, wherein the observed attribute and the market relevance score include a plurality of observed attributes and a plurality of market relevance scores associated with a number of individuals, and before storing the plurality of observed attributes and the plurality of market relevance scores in the market analysis database, storing the plurality of observed attributes and the plurality of market relevance scores in a buffering database, and only if the number of individuals exceeds a threshold number of individuals, storing the plurality of observed attributes and the plurality of market relevance scores in the market analysis database.

Example 82 is the passenger monitoring device of Example 81, wherein the threshold number of individuals depends on a time interval during which the observed attribute and the market relevance are collected in the buffering database.

Example 83 is a method for monitoring a passenger. The method includes monitoring an observed attribute of a passenger in a vehicle, wherein the observed attribute includes a gaze of the passenger and a head track of the passenger. The method also includes determining a field of view of the passenger based on the observed attribute. The method also includes determining a focus point of the passenger within field of view based on the observed attribute. The method also includes determining whether a sign is within the field of view of the passenger. The method also includes recording an attention score for the sign based on a duration of time during which the sign is within the field of view and estimated to be the focus point of the passenger.

Example 84 is the method of Example 83, wherein the method also includes determining for the duration of time an emotional reaction of the passenger associated with the sign.

Example 85 is the method of Example 84, wherein the emotional reaction of the passenger associated with the sign is based on at least one of the observed attribute, a facial expression, a gesture, a change in facial expression, and/or a change in gesture of the passenger.

Example 86 is the method of either Examples 84 or 85, wherein the method also includes classifying the emotional reaction as at least one of a plurality of emotion classifications, wherein the plurality of emotion classifications include happiness, sadness, annoyance, pleasure, displeasure, and/or exampleifference.

Example 87 is the method of any one of Examples 83 to 86, wherein the field of view of the passenger is determined at a map location associated with a geographic location of the vehicle.

Example 88 is the method of any one of Examples 83 to 87, wherein the duration of time includes a sum of a plurality of separate times during which the sign was estimated to be the focus point of the passenger.

Example 89 is the method of any one of Examples 83 to 88, wherein the attention score includes a normalization factor that corresponds to an expected time required to appreciate the sign.

Example 90 is the method of Example 89, wherein the normalization factor includes a constant value based on an extent of content in the sign.

Example 91 is the method of any one of Examples 87 to 90, wherein determining whether the sign is within the field of view includes receiving sign object information associated with the geographic location of the vehicle from a map database containing sign object information for a plurality of signs at the geographic location.

Example 92 is the method of Example 91, wherein the sign object information includes at least one of a position, a pose, a height, a shape, a width, a length, and/or an orientation of the sign.

Example 93 is the method of either Examples 91 or 92, wherein the map database further contains focal point information at the geographic location, wherein the focal point information includes at least one of point of interest information, traffic control device information, and obstacle information at the geographic location, and wherein determining the focus point of the passenger further depends on the focal point information.

Example 94 is the method of Example 93, wherein determining the focus point of the passenger is further based on a first probability associated with the focal point information and a second probability associated with the sign.

Example 95 is the method of any one of Examples 86 to 94, wherein the method also includes storing the classified emotional reaction with the attention score as stored attention impact information in a database.

Example 96 is the method of Example 95, wherein the stored attention impact information further includes the map location associated with the geographic location of the vehicle.

Example 97 is the method of either Examples 95 or 96, wherein the observed attribute includes a plurality of observed attributes of the passenger, wherein the stored attention impact information includes the plurality of observed attributes of the passenger, wherein the plurality of observed attributes include at least one of an age, a gender, and/or a dress-code of the passenger, and wherein the stored attention impact information is anonymized.

Example 98 is the method of any one of Examples 95 to 97, wherein the database further includes a plurality of stored attention impact information received from a plurality of other vehicles at a plurality of map locations.

Example 99 is the method of Example 98, wherein the method also includes determining an average driver distraction time for each of the plurality of map locations based on the plurality of stored attention impact information received from the plurality of other vehicles.

Example 100 is the method of any one of Examples 83 to 99, wherein monitoring the observed attributed includes using sensor information from the vehicle, wherein the sensor information includes at least one of camera information, LiDAR information, and/or depth sensor information.

Example 101 is the method of any one of Examples 83 to 100, wherein the gaze and the head track are determined based on a pose of the head of the passenger and a focus point of the eyes of the passenger.

Example 102 is the method of any one of Examples 83 to 101, wherein the method also includes suggesting a destination for the vehicle based on the attention score and a business location associated with the sign.

Example 103 is the method of any one of Examples 83 to 102, wherein determining the focus point of the passenger is further based on an expected focus point of the passenger.

Example 104 is the method of Example 103, wherein the expected focus point is determined based on an expected response of the passenger to a stimulus.

Example 105 is the method of Example 104, wherein the stimulus includes a stimulus external to the vehicle and/or a synthetic visual stimulus internal to the vehicle.

Example 106 is the method of either Examples 104 or 105, wherein the stimulus includes the sign.

Example 107 is the method of any one of Examples 104 to 106, wherein the stimulus is associated with map data based on a geographic location of the vehicle.

Example 108 is the method of any one of Examples 104 to 107, wherein the expected response is based on information associated with an average response of experienced drivers to the stimulus, wherein the expected response corresponds to at least one of an expected gaze, an expected head track, an expected pupil dilation, and/or an expected blink rate.

Example 109 is the method of any one of Examples 104 to 108, wherein the expected response depends on a motion of the vehicle.

Example 110 is the method of any one of Examples 104 to 109, wherein the method also includes determining an attention level of the passenger based on a difference between the focus point of the passenger and the expected response, and further configured to take an action depending on whether the attention level falls below a threshold attention level.

Example 111 is the method of any one of Examples 104 to 110, wherein the expected response is trained using a supervised deep-neural-network system.

Example 112 is the method of any one of Examples 83 to 111, wherein the observed attribute of the passenger further includes at least one of a face information associated with a face of the passenger, apparel information associated with an apparel worn by the passenger, object information associated with an object of the passenger, gesture information associated with a gesture of the passenger, and/or a location of the passenger within the vehicle.

Example 113 is the method of Example 112, wherein the face information is indicative of at least one of a skin color of the passenger, a gender of the passenger, an age of the passenger, a hair color of the passenger, and/or a hair style of the passenger.

Example 114 is the method of either Examples 112 or 113, wherein the apparel information is indicative of an apparel category including at least one of casual, business, swimming, and/or outdoor.

Example 115 is the method of any one of Examples 112 to 114, wherein the object information is indicative of at least one of a phone, a sports equipment, and/or a walking stick.

Example 116 is the method of any one of Examples 112 to 115, wherein the gesture information is indicative of at least one of a marital status of the passenger and/or a social status of the passenger.

Example 117 is the method of any one of Examples 112 to 116, wherein the method also includes analyzing the observed attribute to estimate a market relevance score of the observed attribute in relation to a targeted advertisement. The method also includes determining whether the market relevance score exceeds a threshold relevance. The method also includes, if the market relevance score exceeds the threshold relevance, storing the observed attribute and the market relevance score associated with the targeted advertisement in a market analysis database.

Example 118 is the method of Example 117, wherein the observed attribute includes a plurality of observed attributes and wherein the market relevance score is determined based on a deep neural network that uses the plurality of observed attributes as input vectors.

Example 119 is the method of Example 118, wherein the method also includes training the deep neural network using a dataset of known market value dependencies for product advertisements that relates a weight of each of the plurality of observed attributes to the market relevance score.

Example 120 is the method of Example 119, wherein the method also includes updating the dataset by changing the weight of at least one of the plurality of observed attributes based on a change in the market relevance score of the observed attribute.

Example 121 is the method of any one of Examples 117 to 120, wherein the method also includes displaying to the passenger a selected advertisement that is selected based on information from the market analysis database and the observed attribute of the passenger.

Example 122 is the method of any one of Examples 117 to 121, wherein the observed attribute and the market relevance score include a plurality of observed attributes and a plurality of market relevance scores associated with a number of individuals, and before storing the plurality of observed attributes and the plurality of market relevance scores in the market analysis database, storing the plurality of observed attributes and the plurality of market relevance scores in a buffering database, and only if the number of individuals exceeds a threshold number of individuals, storing the plurality of observed attributes and the plurality of market relevance scores in the market analysis database.

Example 123 is the method of Example 122, wherein the threshold number of individuals depends on a time interval during which the observed attribute and the market relevance are collected in the buffering database.

Example 124 is one or more non-transient computer readable media, configured to cause one or more processors, when executed, to perform a method for monitoring a passenger. The method stored in the non-transient computer readable media includes monitoring an observed attribute of a passenger in a vehicle, wherein the observed attribute includes a gaze of the passenger and a head track of the passenger. The method also includes determining a field of view of the passenger based on the observed attribute. The method also includes determining a focus point of the passenger within field of view based on the observed attribute. The method also includes determining whether a sign is within the field of view of the passenger. The method also includes and recording an attention score for the sign based on a duration of time during which the sign is within the field of view and estimated to be the focus point of the passenger.

Example 125 is the non-transient computer readable media of Example 124, wherein the method stored in the non-transient computer readable media also includes determining for the duration of time an emotional reaction of the passenger associated with the sign.

Example 126 is the non-transient computer readable media of Example 125, wherein the emotional reaction of the passenger associated with the sign is based on at least one of the observed attribute, a facial expression, a gesture, a change in facial expression, and/or a change in gesture of the passenger.

Example 127 is the non-transient computer readable media of either Examples 125 or 126, wherein the method stored in the non-transient computer readable media also includes classifying the emotional reaction as at least one of a plurality of emotion classifications, wherein the plurality of emotion classifications include happiness, sadness, annoyance, pleasure, displeasure, and/or exampleifference.

Example 128 is the non-transient computer readable media of any one of Examples 124 to 127, wherein the field of view of the passenger is determined at a map location associated with a geographic location of the vehicle.

Example 129 is the non-transient computer readable media of any one of Examples 124 to 128, wherein the duration of time includes a sum of a plurality of separate times during which the sign was estimated to be the focus point of the passenger.

Example 130 is the non-transient computer readable media of any one of Examples 124 to 129, wherein the attention score includes a normalization factor that corresponds to an expected time required to appreciate the sign.

Example 131 is the non-transient computer readable media of Example 130, wherein the normalization factor includes a constant value based on an extent of content in the sign.

Example 132 is the non-transient computer readable media of any one of Examples 128 to 131, wherein determining whether the sign is within the field of view includes receiving sign object information associated with the geographic location of the vehicle from a map database containing sign object information for a plurality of signs at the geographic location.

Example 133 is the non-transient computer readable media of Example 132, wherein the sign object information includes at least one of a position, a pose, a height, a shape, a width, a length, and/or an orientation of the sign.

Example 134 is the non-transient computer readable media of either Examples 132 or 133, wherein the map database further contains focal point information at the geographic location, wherein the focal point information includes at least one of point of interest information, traffic control device information, and obstacle information at the geographic location, and wherein determining the focus point of the passenger further depends on the focal point information.

Example 135 is the non-transient computer readable media of Example 134, wherein determining the focus point of the passenger is further based on a first probability associated with the focal point information and a second probability associated with the sign.

Example 136 is the non-transient computer readable media of any one of Examples 127 to 135, wherein the method stored in the non-transient computer readable media also includes storing the classified emotional reaction with the attention score as stored attention impact information in a database.

Example 137 is the non-transient computer readable media of Example 136, wherein the stored attention impact information further includes the map location associated with the geographic location of the vehicle.

Example 138 is the non-transient computer readable media of either Examples 136 or 137, wherein the observed attribute includes a plurality of observed attributes of the passenger, wherein the stored attention impact information includes the plurality of observed attributes of the passenger, wherein the plurality of observed attributes include at least one of an age, a gender, and/or a dress-code of the passenger, and wherein the stored attention impact information is anonymized.

Example 139 is the non-transient computer readable media of any one of Examples 136 to 138, wherein the database further includes a plurality of stored attention impact information received from a plurality of other vehicles at a plurality of map locations.

Example 140 is the non-transient computer readable media of Example 139, wherein the method stored in the non-transient computer readable media also includes determining an average driver distraction time for each of the plurality of map locations based on the plurality of stored attention impact information received from the plurality of other vehicles.

Example 141 is the non-transient computer readable media of any one of Examples 124 to 140, wherein monitoring the observed attributed includes using sensor information from the vehicle, wherein the sensor information includes at least one of camera information, LiDAR information, and/or depth sensor information.

Example 142 is the non-transient computer readable media of any one of Examples 124 to 141, wherein the gaze and the head track are determined based on a pose of the head of the passenger and a focus point of the eyes of the passenger.

Example 143 is the non-transient computer readable media of any one of Examples 124 to 142, wherein the method stored in the non-transient computer readable media also includes suggesting a destination for the vehicle based on the attention score and a business location associated with the sign.

Example 144 is the non-transient computer readable media of any one of Examples 124 to 143, wherein determining the focus point of the passenger is further based on an expected focus point of the passenger.

Example 145 is the non-transient computer readable media of Example 144, wherein the expected focus point is determined based on an expected response of the passenger to a stimulus.

Example 146 is the non-transient computer readable media of Example 145, wherein the stimulus includes a stimulus external to the vehicle and/or a synthetic visual stimulus internal to the vehicle.

Example 147 is the non-transient computer readable media of either Examples 145 or 146, wherein the stimulus includes the sign.

Example 148 is the non-transient computer readable media of any one of Examples 145 to 147, wherein the stimulus is associated with map data based on a geographic location of the vehicle.

Example 149 is the non-transient computer readable media of any one of Examples 145 to 148, wherein the expected response is based on information associated with an average response of experienced drivers to the stimulus, wherein the expected response corresponds to at least one of an expected gaze, an expected head track, an expected pupil dilation, and/or an expected blink rate.

Example 150 is the non-transient computer readable media of any one of Examples 145 to 149, wherein the expected response depends on a motion of the vehicle.

Example 151 is the non-transient computer readable media of any one of Examples 145 to 150, wherein the method stored in the non-transient computer readable media also includes determining an attention level of the passenger based on a difference between the focus point of the passenger and the expected response, and further configured to take an action depending on whether the attention level falls below a threshold attention level.

Example 152 is the non-transient computer readable media of any one of Examples 145 to 151, wherein the expected response is trained using a supervised deep-neural-network system.

Example 153 is the non-transient computer readable media of any one of Examples 124 to 152, wherein the observed attribute of the passenger further includes at least one of a face information associated with a face of the passenger, apparel information associated with an apparel worn by the passenger, object information associated with an object of the passenger, gesture information associated with a gesture of the passenger, and/or a location of the passenger within the vehicle.

Example 154 is the non-transient computer readable media of Example 153, wherein the face information is indicative of at least one of a skin color of the passenger, a gender of the passenger, an age of the passenger, a hair color of the passenger, and/or a hair style of the passenger.

Example 155 is the non-transient computer readable media of either Examples 153 or 154, wherein the apparel information is indicative of an apparel category including at least one of casual, business, swimming, and/or outdoor.

Example 156 is the non-transient computer readable media of any one of Examples 153 to 155, wherein the object information is indicative of at least one of a phone, a sports equipment, and/or a walking stick.

Example 157 is the non-transient computer readable media of any one of Examples 153 to 156, wherein the gesture information is indicative of at least one of a marital status of the passenger and/or a social status of the passenger.

Example 158 is the non-transient computer readable media of any one of Examples 153 to 157, wherein the method stored in the non-transient computer readable media also includes analyzing the observed attribute to estimate a market relevance score of the observed attribute in relation to a targeted advertisement. The method also includes determining whether the market relevance score exceeds a threshold relevance. The method also includes, if the market relevance score exceeds the threshold relevance, storing the observed attribute and the market relevance score associated with the targeted advertisement in a market analysis database.

Example 159 is the non-transient computer readable media of Example 158, wherein the observed attribute includes a plurality of observed attributes and wherein the market relevance score is determined based on a deep neural network that uses the plurality of observed attributes as input vectors.

Example 160 is the non-transient computer readable media of Example 159, wherein the method stored in the non-transient computer readable media also includes training the deep neural network using a dataset of known market value dependencies for product advertisements that relates a weight of each of the plurality of observed attributes to the market relevance score.

Example 161 is the non-transient computer readable media of Example 160, wherein the method stored in the non-transient computer readable media also includes updating the dataset by changing the weight of at least one of the plurality of observed attributes based on a change in the market relevance score of the observed attribute.

Example 162 is the non-transient computer readable media of any one of Examples 158 to 161, wherein the method stored in the non-transient computer readable media also includes displaying to the passenger a selected advertisement that is selected based on information from the market analysis database and the observed attribute of the passenger.

Example 163 is the non-transient computer readable media of any one of Examples 158 to 162, wherein the observed attribute and the market relevance score include a plurality of observed attributes and a plurality of market relevance scores associated with a number of individuals, and before storing the plurality of observed attributes and the plurality of market relevance scores in the market analysis database, storing the plurality of observed attributes and the plurality of market relevance scores in a buffering database, and only if the number of individuals exceeds a threshold number of individuals, storing the plurality of observed attributes and the plurality of market relevance scores in the market analysis database.

Example 164 is the non-transient computer readable media of Example 163, wherein the threshold number of individuals depends on a time interval during which the observed attribute and the market relevance are collected in the buffering database.

Example 165 is an apparatus for monitoring a passenger that includes a means for monitoring an observed attribute of a passenger in a vehicle, wherein the observed attribute includes a gaze of the passenger and a head track of the passenger. The apparatus also includes a means for determining the field of view of the passenger based on the observed attribute. The apparatus also includes a means for determining a focus point of the passenger within field of view based on the observed attribute. The apparatus also includes a means for determining whether a sign is within the field of view of the passenger. The apparatus also includes a means for recording an attention score for the sign based on a duration of time during which the sign is within the field of view and estimated to be the focus point of the passenger.

Example 166 is the apparatus of Example 165, wherein the apparatus also includes a means for determining for the duration of time an emotional reaction of the passenger associated with the sign.

Example 167 is the apparatus of Example 166, wherein the emotional reaction of the passenger associated with the sign is based on at least one of the observed attribute, a facial expression, a gesture, a change in facial expression, and/or a change in gesture of the passenger.

Example 168 is the apparatus of either Examples 166 or 167, wherein the apparatus also includes a means for classifying the emotional reaction as at least one of a plurality of emotion classifications, wherein the plurality of emotion classifications include happiness, sadness, annoyance, pleasure, displeasure, and/or exampleifference.

Example 169 is the apparatus of any one of Examples 165 to 168, wherein the field of view of the passenger is determined at a map location associated with a geographic location of the vehicle.

Example 170 is the apparatus of any one of Examples 165 to 169, wherein the duration of time includes a sum of a plurality of separate times during which the sign was estimated to be the focus point of the passenger.

Example 171 is the apparatus of any one of Examples 165 to 170, wherein the attention score includes a normalization factor that corresponds to an expected time required to appreciate the sign.

Example 172 is the apparatus of Example 171, wherein the normalization factor includes a constant value based on an extent of content in the sign.

Example 173 is the apparatus of any one of Examples 169 to 172, wherein determining whether the sign is within the field of view includes receiving sign object information associated with the geographic location of the vehicle from a map database containing sign object information for a plurality of signs at the geographic location.

Example 174 is the apparatus of Example 173, wherein the sign object information includes at least one of a position, a pose, a height, a shape, a width, a length, and/or an orientation of the sign.

Example 175 is the apparatus of either Examples 173 or 174, wherein the map database further contains focal point information at the geographic location, wherein the focal point information includes at least one of point of interest information, traffic control device information, and obstacle information at the geographic location, and wherein determining the focus point of the passenger further depends on the focal point information.

Example 176 is the apparatus of Example 175, wherein determining the focus point of the passenger is further based on a first probability associated with the focal point information and a second probability associated with the sign.

Example 177 is the apparatus of any one of Examples 168 to 176, wherein the apparatus also includes a means for storing the classified emotional reaction with the attention score as stored attention impact information in a database.

Example 178 is the apparatus of Example 177, wherein the stored attention impact information further includes the map location associated with the geographic location of the vehicle.

Example 179 is the apparatus of either Examples 177 or 178, wherein the observed attribute includes a plurality of observed attributes of the passenger, wherein the stored attention impact information includes the plurality of observed attributes of the passenger, wherein the plurality of observed attributes include at least one of an age, a gender, and/or a dress-code of the passenger, and wherein the stored attention impact information is anonymized.

Example 180 is the apparatus of any one of Examples 177 to 179, wherein the database further includes a plurality of stored attention impact information received from a plurality of other vehicles at a plurality of map locations.

Example 181 is the apparatus of Example 180, wherein the apparatus also includes a means for determining an average driver distraction time for each of the plurality of map locations based on the plurality of stored attention impact information received from the plurality of other vehicles.

Example 182 is the apparatus of any one of Examples 165 to 181, wherein monitoring the observed attributed includes using sensor information from the vehicle, wherein the sensor information includes at least one of camera information, LiDAR information, and/or depth sensor information.

Example 183 is the apparatus of any one of Examples 165 to 182, wherein the gaze and the head track are determined based on a pose of the head of the passenger and a focus point of the eyes of the passenger.

Example 184 is the apparatus of any one of Examples 165 to 183, wherein the apparatus also includes a means for suggesting a destination for the vehicle based on the attention score and a business location associated with the sign.

Example 185 is the apparatus of any one of Examples 165 to 184, wherein determining the focus point of the passenger is further based on an expected focus point of the passenger.

Example 186 is the apparatus of Example 185, wherein the expected focus point is determined based on an expected response of the passenger to a stimulus.

Example 187 is the apparatus of Example 186, wherein the stimulus includes a stimulus external to the vehicle and/or a synthetic visual stimulus internal to the vehicle.

Example 188 is the apparatus of either Examples 186 or 187, wherein the stimulus includes the sign.

Example 189 is the apparatus of any one of Examples 186 to 188, wherein the stimulus is associated with map data based on a geographic location of the vehicle.

Example 190 is the apparatus of any one of Examples 186 to 189, wherein the expected response is based on information associated with an average response of experienced drivers to the stimulus, wherein the expected response corresponds to at least one of an expected gaze, an expected head track, an expected pupil dilation, and/or an expected blink rate.

Example 191 is the apparatus of any one of Examples 186 to 190, wherein the expected response depends on a motion of the vehicle.

Example 192 is the apparatus of any one of Examples 186 to 191, wherein the apparatus also includes a means for determining an attention level of the passenger based on a difference between the focus point of the passenger and the expected response. The apparatus also includes a means for taking an action depending on whether the attention level falls below a threshold attention level.

Example 193 is the apparatus of any one of Examples 186 to 192, wherein the expected response is trained using a supervised deep-neural-network system.

Example 194 is the apparatus of any one of Examples 165 to 193, wherein the observed attribute of the passenger further includes at least one of a face information associated with a face of the passenger, apparel information associated with an apparel worn by the passenger, object information associated with an object of the passenger, gesture information associated with a gesture of the passenger, and/or a location of the passenger within the vehicle.

Example 195 is the apparatus of Example 194, wherein the face information is indicative of at least one of a skin color of the passenger, a gender of the passenger, an age of the passenger, a hair color of the passenger, and/or a hair style of the passenger.

Example 196 is the apparatus of either Examples 194 or 195, wherein the apparel information is indicative of an apparel category including at least one of casual, business, swimming, and/or outdoor.

Example 197 is the apparatus of any one of Examples 194 to 196, wherein the object information is indicative of at least one of a phone, a sports equipment, and/or a walking stick.

Example 198 is the apparatus of any one of Examples 194 to 197, wherein the gesture information is indicative of at least one of a marital status of the passenger and/or a social status of the passenger.

Example 199 is the apparatus of any one of Examples 194 to 198, wherein the apparatus also includes a means for analyzing the observed attribute to estimate a market relevance score of the observed attribute in relation to a targeted advertisement. The apparatus also includes a means for determining whether the market relevance score exceeds a threshold relevance, and if the market relevance score exceeds the threshold relevance. The apparatus also includes a means for storing the observed attribute and the market relevance score associated with the targeted advertisement in a market analysis database.

Example 200 is the apparatus of Example 199, wherein the observed attribute includes a plurality of observed attributes and wherein the market relevance score is determined based on a deep neural network that uses the plurality of observed attributes as input vectors.

Example 201 is the apparatus of Example 200, wherein the apparatus also includes a means for training the deep neural network using a dataset of known market value dependencies for product advertisements that relates a weight of each of the plurality of observed attributes to the market relevance score.

Example 202 is the apparatus of Example 201, wherein the apparatus also includes a means for updating the dataset by changing the weight of at least one of the plurality of observed attributes based on a change in the market relevance score of the observed attribute.

Example 203 is the apparatus of any one of Examples 199 to 202, wherein the apparatus also includes a means for displaying to the passenger a selected advertisement that is selected based on information from the market analysis database and the observed attribute of the passenger.

Example 204 is the apparatus of any one of Examples 199 to 203, wherein the observed attribute and the market relevance score include a plurality of observed attributes and a plurality of market relevance scores associated with a number of individuals, and before storing the plurality of observed attributes and the plurality of market relevance scores in the market analysis database, storing the plurality of observed attributes and the plurality of market relevance scores in a buffering database, and only if the number of individuals exceeds a threshold number of individuals, storing the plurality of observed attributes and the plurality of market relevance scores in the market analysis database.

Example 205 is the apparatus of Example 204, wherein the threshold number of individuals depends on a time interval during which the observed attribute and the market relevance are collected in the buffering database.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

Claimed is:

1. A passenger monitoring system comprising:
a processor configured to:
monitor an observed attribute of a passenger in a vehicle, wherein the observed attribute comprises a gaze of the passenger and a head track of the passenger;
determine a field of view of the passenger based on the observed attribute;
determine a focus point of the passenger within field of view based on the observed attribute;
determine whether a sign is within the field of view of the passenger; and
record an attention score for the sign based on a duration of time during which the sign is within the field of view and estimated to be the focus point of the passenger.

2. The passenger monitoring system of claim 1, wherein the processor is further configured to determine for the duration of time an emotional reaction of the passenger associated with the sign, wherein the emotional reaction is based on at least one of the observed attribute, a facial expression, a gesture, a change in facial expression, and/or a change in gesture of the passenger.

3. The passenger monitoring system of claim 2, wherein the processor is further configured to classify the emotional reaction as at least one of a plurality of emotion classifications, wherein the plurality of emotion classifications comprises at least two of happiness, sadness, annoyance, pleasure, displeasure, and/or indifference.

4. The passenger monitoring system of claim 1, wherein the field of view of the passenger is determined at a map location associated with a geographic location of the vehicle.

5. The passenger monitoring system of claim 1, wherein the duration of time comprises a sum of a plurality of separate times during which the sign is estimated to be the focus point of the passenger.

6. The passenger monitoring system of claim 1, wherein the attention score is further based on a normalization factor that corresponds to an expected time required to appreciate the sign.

7. The passenger monitoring system of claim 4, wherein determining whether the sign is within the field of view comprises receiving sign object information associated with the map location from a map database containing sign object information for a plurality of signs at the map location, wherein the sign object information comprises at least one of a position, a pose, a height, a shape, a width, a length, and/or an orientation of the sign.

8. The passenger monitoring system of claim 7, wherein the map database further contains focal point information at the map location, wherein the focal point information comprises at least one of point of interest information, traffic control device information, and obstacle information at the map location, and wherein determining the focus point of the passenger further depends on the focal point information.

9. The passenger monitoring system of claim 8, wherein determining the focus point of the passenger is further based on a first probability associated with the focal point information and a second probability associated with the sign.

10. The passenger monitoring system of claim 3, wherein the processor is further configured to store the classified emotional reaction with the attention score as stored attention impact information in a database, wherein the stored attention impact information further comprises a map location associated with a geographic location of the vehicle.

11. The passenger monitoring system of claim 10, wherein the database further comprises a plurality of stored attention impact information received from a plurality of other vehicles at a plurality of map locations, and wherein the processor is further configured to determine an average driver distraction time for each of the plurality of map locations based on the plurality of stored attention impact information received from the plurality of other vehicles.

12. The passenger monitoring system of claim 1, wherein determining the focus point of the passenger is further based on an expected focus point of the passenger, wherein the expected focus point is determined based on an expected response of the passenger to a stimulus.

13. The passenger monitoring system of claim 12, wherein the expected response is based on information associated with an average response of experienced drivers to the stimulus, wherein the expected response corresponds to at least one of an expected gaze, an expected head track, an expected pupil dilation, and/or an expected blink rate.

14. The passenger monitoring system of claim 12, wherein the processor is further configured to determine an attention level of the passenger based on a difference between the focus point of the passenger and the expected response, and further configured to take an action depending on whether the attention level falls below a threshold attention level.

15. The passenger monitoring system of claim 1, wherein the processor is further configured to:
analyze the observed attribute to estimate a market relevance score of the observed attribute in relation to a targeted advertisement;
determine whether the market relevance score exceeds a threshold relevance; and
store the observed attribute and the market relevance score associated with the targeted advertisement in a market analysis database, if the market relevance score exceeds the threshold relevance.

16. The passenger monitoring system of claim 15, wherein the observed attribute of the passenger further comprises at least one of a face information associated with a face of the passenger, apparel information associated with an apparel worn by the passenger, object information associated with an object of the passenger, gesture information associated with a gesture of the passenger, and/or a location of the passenger within the vehicle.

17. The passenger monitoring system of claim 12, wherein the observed attribute and the market relevance score comprise a plurality of observed attributes and a plurality of market relevance scores associated with a number of individuals, and before storing the plurality of observed attributes and the plurality of market relevance scores in the market analysis database, storing the plurality of observed attributes and the plurality of market relevance scores in a buffering database, and after the number of individuals exceeds a threshold number of individuals, storing the plurality of observed attributes and the plurality of market relevance scores in the market analysis database.

18. A device for monitoring a passenger in a vehicle, the device comprising:
monitoring means for monitoring a plurality of observed attributes of the passenger in the vehicle;
determining means for determining a field of view of the passenger based on the plurality of observed attributes;
determining means for determining a focus point of the passenger within field of view based on the plurality of observed attributes;
determining means for determining whether a sign is within the field of view of the passenger; and
recording means for recording an attention score for the sign based on a duration of time during which the sign is within the field of view and estimated to be the focus point of the passenger.

19. The device of claim 18, further comprising classifying means for classifying an emotional reaction of the passenger based on the plurality of observed attributes and storing the classified emotional reaction with the attention score and the plurality of observed attributes as anonymized attention impact information in a database.

20. The device of claim 18, wherein the focus point of the passenger is further based on an expected response of the passenger to the sign, wherein the expected response is based on information associated with an average response to the stimulus and depends on a motion of the vehicle.

21. A non-transitory computer readable medium, comprising instructions which, if executed, cause one or more processors to:
monitor an observed attribute of the passenger in the vehicle;
determine a field of view of the passenger based on the observed attribute;
determine a focus point of the passenger within field of view based on the observed attribute;
determine whether a sign is within the field of view of the passenger; and
record an attention score for the sign based on a duration of time during which the sign is within the field of view and estimated to be the focus point of the passenger.

22. The non-transitory computer readable medium of claim 21, wherein the instructions are further configured to cause the one or more processors to classify an emotional reaction of the passenger based on the observed attribute and storing the classified emotional reaction with the attention score and the observed attribute as anonymized attention impact information in a database.

23. The non-transitory computer readable medium of claim 21, wherein the focus point of the passenger is further based on an expected response of the passenger to the sign, wherein the expected response is based on information associated with an average response to the stimulus and depends on a motion of the vehicle.

24. The non-transitory computer readable medium of claim 21, wherein the gaze and the head track are determined based on a pose of the head of the passenger and a focus point of the eyes of the passenger.

25. The non-transitory computer readable medium of claim 21, wherein the instructions are further configured to cause the one or more processors to:
analyze the observed attribute to estimate a market relevance score of the observed attribute in relation to a targeted advertisement;
determine whether the market relevance score exceeds a threshold relevance; and
store the observed attribute and the market relevance score associated with the targeted advertisement in a market analysis database, if the market relevance score exceeds the threshold relevance.
